(19) United States
(12) Patent Application Publication
(10) Pub. No.: US 2010/0300220 A1
(43) Pub. Date: Dec. 2, 2010

(54) METHOD FOR MONITORING AN ENERGY CONVERSION DEVICE

(75) Inventors: Pierre Vadstrup, Brabrand (DK); Jette Egebaek Vadstrup, Brabrand (DK); Carsten Skovmose Kallesoe, Viborg (DK)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: GRUNDFOS MANAGEMENT A/S, Bjerringbro (DK)

(21) Appl. No.: 12/679,054

(22) PCT Filed: Aug. 28, 2008
(86) PCT No.: PCT/EP2008/007041

§ 371 Date: Mar. 19, 2010

(30) Foreign Application Priority Data
Sep. 20, 2007 (EP) 07018530.1

(51) Int. Cl. G01L 3/26

(52) U.S. Cl. 73/865.9

(57) ABSTRACT

The method serves for monitoring an energy conversion device such as for example a pump assembly, a compressor or likewise. The energy conversion device consists of several function units which are functionally linked to one another. Power-dependent variables of at least one function unit are automatically detected in temporal intervals and/or computed and compared to one another or values derived therefrom and/or to predefined values. A corresponding signal is produced in dependence of this comparison, via which signal, the efficiency reduction of a function unit or the complete device may be specified.

### CROSS-REFERENCE TO RELATED APPLICATIONS

This application is a Section 371 of International Application No. PCT/EP2008/007041, filed Aug. 28, 2008, which was published in the German language on Apr. 2, 2009, under International Publication No. WP 2009/039934 A1 and the disclosure of which is incorporated herein by reference.

### BACKGROUND OF THE INVENTION

The invention relates to a method for monitoring an energy conversion device which consists of several function units which are functionally linked to one another. Such energy conversion devices in the context of the invention may for example be electric motor driven centrifugal pump assemblies, electric motor driven compressors and installations equipped with the foregoing. Typical installations may include several function units which are functionally linked to one another, such as for example electric motor and centrifugal pump, or electric motor and displacement pump or combustion engine and electrical generator. Such energy conversion devices nowadays are used in almost all technical, but also domestic fields.

In the course of resources becoming scarcer, one constantly strives in constructing machines, installations or other energy conversion devices, such that they operate with as high as possible efficiency over a long time. In practice however, there is often the problem that the initially high efficiencies deteriorate and the devices continue to be operated although they have for some time no longer the desired efficiency. These phenomena may be observed for example with heating circulation pumps or with refrigerators. An exchange is effected typically only when a defect is evident or the device completely fails in the normal service.

In many cases however, it would make economic sense to previously exchange the device or at least replace or remedy the defect of an insufficiently functioning function unit.

Against this background, the solution according to the invention envisages providing a method for monitoring an energy conversion device which consists of several function units which are functionally linked to one another, with which the power-dependent variables of at least one function unit are detected and/or computed automatically at temporal intervals and are compared to one another or to values derived therefrom and/or to predefined values, and a corresponding signal is produced in dependence on this comparison. Then, by way of this signal, one may ascertain whether the device still functions with the desired efficiency, as the case may, whether one or also more function units do not exhibit a sufficient performance and thus one may determine whether the device is to be repaired or exchanged.

### BRIEF SUMMARY OF THE INVENTION

The basic concept of the method according to the invention lies in monitoring at least one function unit in temporal intervals with regard to its efficiency, and in displaying the result by way of a signal, or making it able to be automatically evaluated. Thereby, in the simplest form, power-dependent variables of a function unit are automatically detected in temporal intervals and compared to predefined values, to previously determined values or values derived therefrom. Thus for example, by way of comparison of a power-dependent variable of one of the function units of the device, said variable determined directly after starting operation of the device, and comparison with predefined values, one may determine whether the performance which is envisaged on the part of the factory is accomplished at all or not. Then in further, preferably larger temporal intervals, by way of comparison of at least one power-dependent variable, one may determine whether and to what extent the efficiency of the functioning unit has worsened. Thereby, advantageously according to the invention, not only one, but usefully all function units essentially determining the efficiency of the device are monitored in the previously described manner. An energy conversion device, thus in particular an assembly, a machine or an installation, may determine and display its individual power characteristics, the operating behaviour resulting therefrom, the life expectancy and likewise, in a self-learning manner by way of the monitoring of the power behaviour and suitable signal processing,

Power-dependent variables in the context of the present invention are those which are in any relation to the power characteristics of a function unit. Thus for example, with assemblies operating in a discontinuous manner, for example such as the compressor of a refrigerator, the temporal course of the switching on and switching off procedures may also be a power-dependent variable in the context of the present invention.

Advantageous designs of the method according to the invention, as well as devices operating according to the method according to the invention are specified in the further claims as well as the subsequent description and drawing.

According to an advantageous further formation of the invention, power-dependent variables of at least two function units functionally linked to one another, preferably of all function units, are automatically detected and/or computed in temporal intervals, wherein the power-dependent output variables or variables derived therefrom, of the one function unit, form the power-dependent input variables of the function unit which is functionally arranged after this.

One may apply mathematical models with the computation by way of this link, and the previously mentioned monitoring tasks may be reliably ensured on the basis of only comparatively few variables to be measured.

The inventive efficiency monitoring of the device or at least of individual function units of the device may be effected in a comparatively simple manner, if the function units always run at the same operating point, since then, typically one reading is sufficient in order to determine the correct or reduced power/efficiency of the respective unit. This however is more complicated if an energy conversion device such as a heating circulation pump is to be monitored. Such assemblies consist typically of the function units of the motor and centrifugal pump, wherein the centrifugal pump typically constantly changes its operating point, since the pipe network resistance of the heating installation changes on account of external influences. In order here to have comparable power-dependent variables, it is useful to use the variables resulting on account of an electrical-mechanical motor model as well as a mechanical-hydraulic pump model, at the interface between the motor and the pump, in order in this manner to determine the power condition of the pump assembly. Alternatively, the determining may also be effected by way of determining two hydraulic variables of the pump, typically the delivery rate and the delivery head and, via a suitable model computation, equating them with the mechanical power delivered by the motor.

With such devices, with which the operating points constantly change and thus it is to be assumed that with measurements effected at a temporal interval, it is presumably not the same operating point which is reached again, it is particularly advantageous to carry out several measurements in temporally short intervals and to determine power-dependent, as the case may be, multidimensional surface courses at the interfaces of the function units to one another, by way of the thus determined operating points, and comparing these to previously determined ones. Thereby, these surfaces determined by computation are advantageously approximated using a Kalman filter, so that one may determine the respective power-determining surface in a sufficiently accurate manner already with comparatively few measurements. The distance of such surfaces in a certain operating point, which are determined in a longer temporal interval, or the volume spanned between the surfaces, may be used as a measure for the efficiency change, typically the efficiency reduction.

Advantageously, the method according to the invention is carried out during normal operation of the device, thus with a pump assembly, during the intended delivery operation, wherein the temporal interval for detecting the quasi simultaneous operating points for determining the surface course may lie for example in the region of minutes, wherein the time interval after which a comparative measure is carried out, may lie in the daily, weekly or monthly range, depending on the apparatus type. Comparatively long intervals would result e.g. with heating circulation pumps, whereas short intervals may be particularly useful with compressors, in particular for cooling installations, since with such a monitoring method, not only may a worsening of the efficiency be detected, but also a failure of the device which could possibly be expected.

The temporal interval, in which the power-dependent variables which are present for comparison are determined, thus depends on the machine type as well as the application purpose. The comparison is however usefully effected on the basis of the previously detected variables or defined values, wherein the latter method has the advantage that one may already detect a poor functioning on starting operation with it.

The method according to the invention may be carried out with significantly less effort with regard to measurement technology and computation, if, firstly, an electrical variable of the motor determining the power uptake of the motor, and at least one variable determining the hydraulic operating point of the pump, is detected and stored and, for the later comparative measurement, one waits until the previously detected hydraulic operating point is reached again, and then the variables of the motor which determine the power uptake are detected and compared to the firstly stored ones. A direct comparison may then be effected without operating point deviations and thus without the previously mentioned surface courses having to be determined.

Alternatively, the variables which are detected later for comparative measurement may be detected at any operating point of the installation if the detected variables are transferred on the basis of a mathematical, electrical motor model and/or a mathematical-hydraulic pump model, i.e. are converted to variables independent of the operating point, and then compared to the stored variables, or vice versa, so that a comparison of the variables determining the power is also possible independently of the operating point.

Advantageously, according to the invention, the method is not applied until after the completion of a predefined time, wherein this predefined time corresponds at least to the running-in phase of the assembly, in particular of the pump assembly. This makes sense, so that the mechanical parts of the assembly may become settled in operation, and any running-in resistances in the bearings are overcome and then after the running-in phase, a firstly quasi stationary operating condition may be achieved, which forms a basis for the normal power-determining characteristics of the apparatus, so that only deviations from this condition may be detected later.

Hereby, it is particularly advantageous if, after completion of the predefined time, thus typically the running-in phase, at least one operating profile is automatically detected and the expected energy consumption is determined taking into account the efficiency change which is determined as the case may be, and is displayed by way of suitable means. It is possible with this method, after the running-in phase, to automatically determine whether the assembly fulfills the values specified with regard to power/efficiency, or whether a changed energy consumption which exceeds this is to be expected, on account of a worsening of the efficiency.

According to an advantageous further formation of the method according to the invention, for a comparative measurement, it is not necessary to run to the same operating point. Rather, by way of several operating points, a surface course which depends on the power of a function unit and which has a multidimensional model character may be determined and stored, and such a surface course may be determined and stored afresh at temporal intervals, and compared to the or a previously determined one, wherein the distance of the surface courses in a predefined operating point or operating region or the volume spanned between the surface courses is used as a measure for the efficiency change. Such an evaluation is particularly advantageous since it may be effected during the continuous operation without any intervention into the operating behaviour of the machine. Such a method is particularly advantageous with centrifugal pump assemblies, as are applied for example as heating circulation pumps, which usually run at constantly changing operating points. Advantageously, a Kalman filter is used for determining the surface course by way of the operating points. This iteration method permits one to determine the surface course in a sufficiently accurate manner with only a comparatively small number of measured operating points, in order to be able to detect the deviations which are being discussed here and to be able to determine them quantitively.

The method according to the invention may basically be applied for monitoring with any energy conversion devices which consist of several function units which are functionally linked to one another. The application is particularly advantageous with centrifugal pump assemblies, with compressors, with heating installations, with refrigerators, deep freezes and likewise, which typically are operated over years and decades without a worsening of the efficiency becoming evident or a failure being predicted. Thus the monitoring method according to the invention is suitable for detecting and displaying a poor running, thus a worsening of the efficiency, which would appear to render a premature exchange of the assembly or of at least of a function unit of the assembly economically sensible, as well as for being able to display the expected failure of the assembly, in order to ensure a replacement in due time, as is particularly advantageous with refrigerators or deep freezes. The method according to the invention may also be applied with larger machines whose standstill would entail economical consequences, in order to display an impeding failure in good time. It is to be understood that then, usefully respective characteristic values are set, which were previously determined in laboratory trials, so that the failure time may be determined at least in a coarse manner by way of the efficiency change or the course of the power change of the machine.

The method according to the invention may advantageously be implemented in the form of a software program into the digital control and regulation electronics which are present in modern assemblies in any case. With pump assemblies and compressors, such control and regulation electronics may be provided in the assembly itself as well as in the terminal box or connection box of the assembly.

Advantageously, the device according to the invention is applied with a centrifugal pump assembly with an electrical motor and a centrifugal pump which is driven by this, in a device provided there, for monitoring the power characteristics of at least one function unit of the assembly. Such a device for monitoring the power characteristics, in particularly for detecting and monitoring the efficiency, which functions according to the method according to the invention, may also be provided with a compressor assembly with an electric motor and a displacement pump which is driven by this. Advantageously, one may provide a cooling assembly with an electrical motor, with a displacement pump driven by this, with an evaporator and with a condenser, with a device for monitoring the power characteristics, which functions according to the method according to the invention, wherein the monitoring of the power characteristics is not only limited to the motor and displacement pump, but also advantageously also encompasses the evaporator and the condenser.

It is particularly with refrigerators that a reduction of the efficiency is to be determined by way of the running time of the compressor being monitored after installation of the device. This may be effected for example by way of determining the running time within 24 hours and then later, for example after six months, being compared to the running time within 24 hours which then results. In the simplest form, it is to be assumed that on account of constant environmental conditions and user behaviour, an increasing switch-on duration is caused by a worsening of the efficiency of the installation. More accurate information may be determined by way of an analysis of the temporal course of the compressor running time.

In an analogous manner, with a heating installation, one may provide a device for monitoring the power characteristics of the combustor and at least one water circuit which may be heated by this, in order in this manner, to be able to detect combustion residues on the primary heat exchanger and thus a worsening of the efficiency which this entails. Here, by way of attaching a suitable signal lamp, thus also a hint with regard to the necessary cleaning service may be issued, which thus may be determined depending on requirement.

Usefully the device is designed such that after a predefined time after starting operation of the assembly or of the installation, it automatically begins with the detection and storage of the variables which are relevant for monitoring the power characteristics, in particular for determining and monitoring the efficiency, and renews the detection of these variables at suitable temporal intervals and compares these to the previously stored variables and/or the originally stored variables and displays a high deviation which may be too high as the case may be. The device therefore, according to a further formation of the invention, advantageously comprises a reading memory, in which at least the variables detected at the beginning of the measurement or variables derived therefrom are stored.

Usefully, the machine where possible is monitored in its entirely with the method according to the invention. However, it may be sufficient to only monitor one function unit of the machine. This makes particular sense if the machine has a function unit which typically fails significantly before all other function units by way of wear or in another manner.

It is particularly advantageous if several or preferably all function units of an energy conversion device, thus of a machine, of an assembly or of an installation, are detected, in order, in the case of a worsening of the efficiency, to be able to attribute this in a targeted manner, to one or more function units, in order then in a targeted manner to repair or exchange only this function unit or function units. This makes particular economic sense, in particular with larger machines.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 by way of an illustratory picture, the basic principle of a monitoring method according to the invention functioning with power surfaces,

FIG. 2a the monitoring method according to FIG. 1, represented by way of a centrifugal pump assembly,

FIG. 2b an alternative monitoring method for a centrifugal pump,

FIG. 2c a further variant of a monitoring method for a centrifugal pump,

FIG. 3 a monitoring method, represented by way of a compressor,

FIG. 4 a monitoring method, represented by way of a cooling apparatus;

and

FIG. 5 a monitoring method, represented by way of a heating installation.

### DETAILED DESCRIPTION OF THE INVENTION

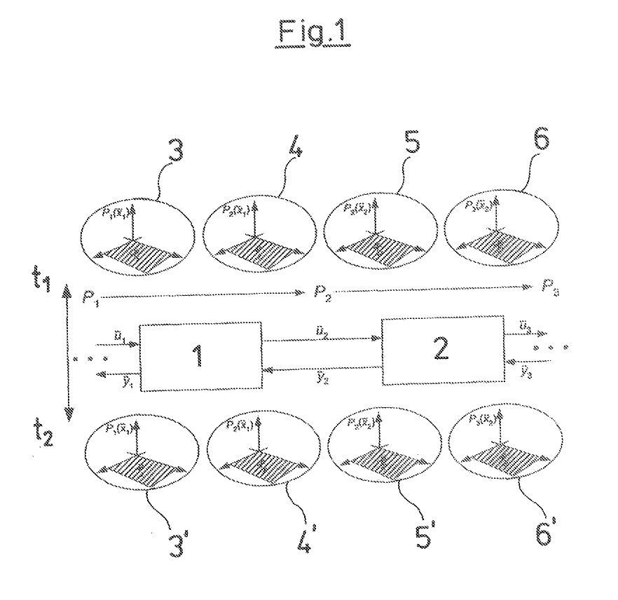

An energy conversion device consisting of the function units 1 and 2 by way of example for a multitude of machines, installations and assemblies, is represented in FIG. 1. In the represented embodiment example, the function units 1 and 2 are monitored independently of one another. Thereby, firstly as a one-off, the power P₁ taken up by the function unit 1 is detected in dependence on one or more variables x̅₁ and stored, as is illustrated in FIG. 1 at 3. The variables x̅₁ are formed by ū₁ and y̅₁, so that the area represented in 3 corresponds to the energy balance of the function unit 1 at the entry. Accordingly, a power P₂ sets in at the exit, which in turn is dependent on the variables x̅₁. This area is represented in 4. The function units 1 and 2 are functionally connected to one another, e.g. via a shaft, which is why the representation 4 corresponds to the representation 5, which here defines the power P₂ in dependence on x̅₂ according to the energy balance at the entry of the function unit 2, and specifically in dependence on the variables ū₂ and y̅₂. A power P₂ sets in at the exit of the function unit 2, as it is represented in 6 and is dependent on x̅₂.

The surfaces characterised in the representations 3 to 6 by the hatching are determined at the beginning of the method. This may be effected on the part of the factory, but also only after a certain time in operation. This may be effected as an initialisation procedure or also during the operation. In any case it is effected at the point in time t₁ which, when several operating points are to be detected, may also represent a time region.

Then, in the same manner, an energy balance at the entry of the function unit 1, at the exit of the function unit 1, at the entry of the function unit 2 and at the exit of the function unit 2, is created at a point in time t₂. The respective representations are indicated at 3′, 4′, 5′ and 6′. By way of comparison of these variables or surfaces determined at the point in time t₂ which may likewise be a time region, with the variables or surfaces determined at the point in time t₁ and stored, one may detect efficiency reductions of individual function units 1, 2, wherein the distance of the hatched surfaces in 3 and 3′ or 4 and 4′ or 5 and 5′ or 6 and 6′ are determined in a predefined operating point or the volume spanned between these surfaces is determined, and on exceeding a predefined value, a signal is produced, which makes the user aware of the fact that a worsening of the efficiency has taken place in the machine, which would appear to render an exchange or repair or an immediate exchange or an immediate repair useful. Here, by way of grading the values, different signals are produced, for example a first warning signal which indicates an efficiency reduced beyond a certain value, and a second warning signal, which indicates such a reduction of the efficiency, which requires an exchange or a repair. Since the function units 1 and 2 are monitored separately from one another, one may further ascertain which of the function units is completely or partly responsible for the reduction in efficiency.

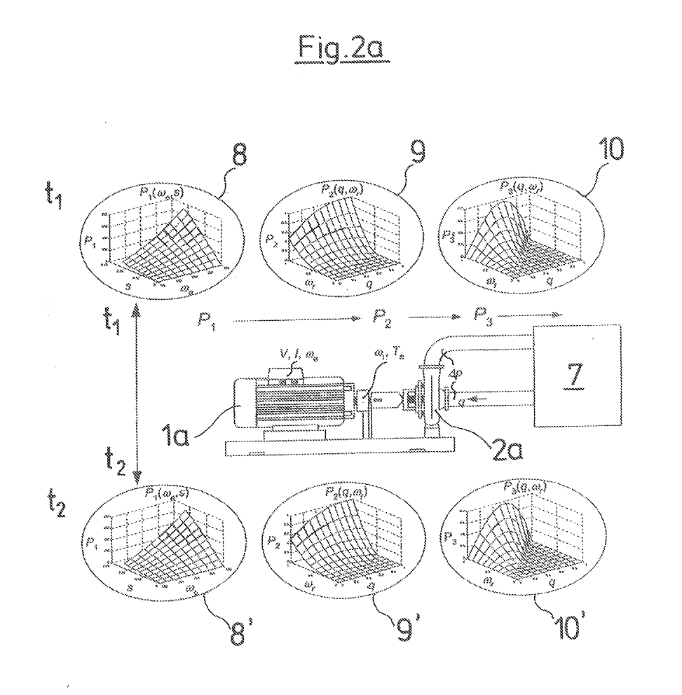

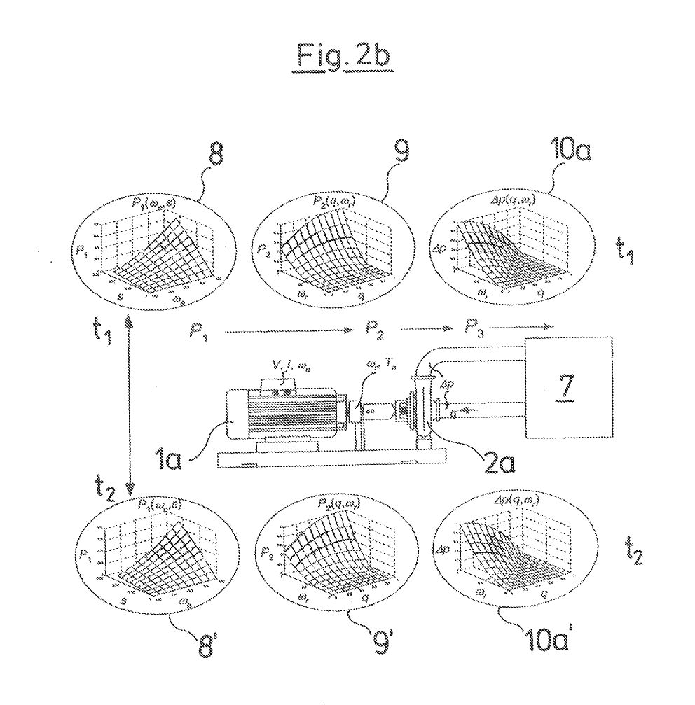

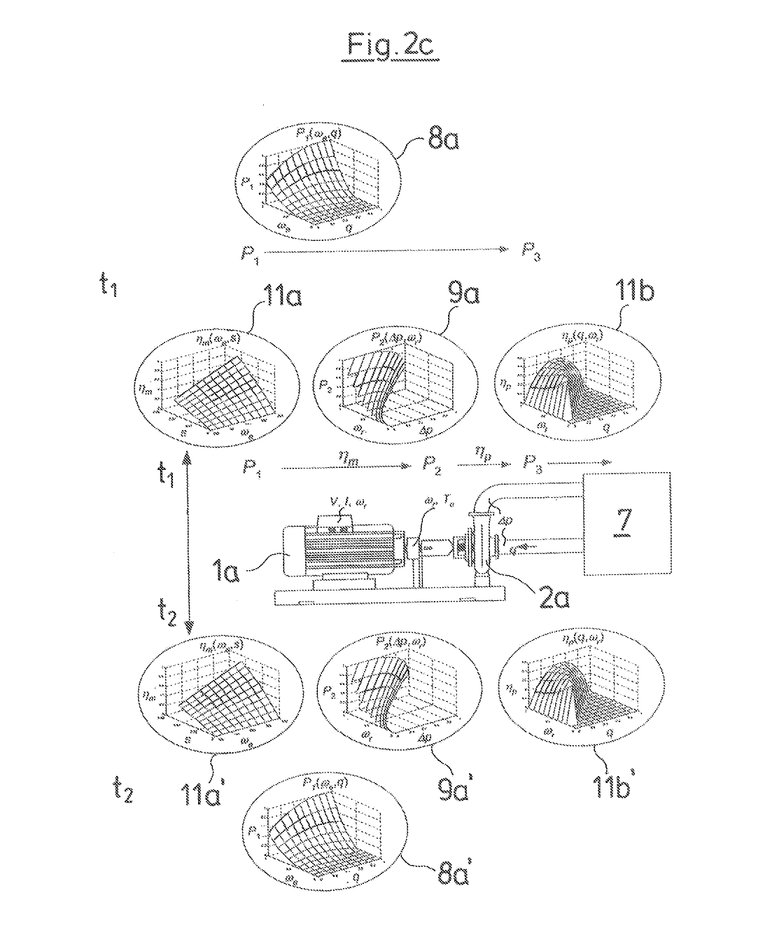

By way of example, it is shown by way of FIG. 2a, b and c as to how this may look with a specific application. What is represented there is a device consisting of an electric motor 1a and a pump 2a, which feeds a consumer 7. The electrical power which is taken up by the motor 1a is indicated at P₁. The motor converts the electrical power into a torque Tₑ at a rotational speed ωᵣ. This mechanical power P₂ prevailing at the exit of the motor 1a at the same time represents the mechanical power P₂ which prevails at the entry of the pump 2 and which is determined by the pressure difference Δp produced by the pump between the suction side and the pressure side, and the volume flow through the pump q. In order to completely monitor the device consisting of the motor 1a and the pump 2a represented by way of FIG. 2a, it is necessary to determine at the respective interfaces, the areas which encompass the power of the respective function unit at every possible operating point, and specifically at the entry and at the exit of these.

The formula relationship thereby is represented as follows:

Variable:

q˜volume flow through the pump [m³/h]

Δp˜differential pressure built up by the pump

ωᵣ˜speed of the shaft driving the pump [U/sec]

Tₑ˜torque of the shaft [Nm]

V˜supply voltage [V]

I˜supply current [A]

φ˜angle between the supply voltage V and the motor current I [U]

ωₑ˜supply frequency [U/sec]

P₁˜the electrical power fed to the motor [W]

P₂˜mechanical power at the motor shaft [W]. The power P₂ is proportional to the slip s of the motor. This is P₂∝s.

P₃˜hydraulic power of the pump [W]

ηₘ˜motor efficiency

ηₚ˜pump efficiency

These variables are related to one another as follows:

P₁=VI cos(φ)

P₂=ωᵣTₑ

P₃=κqΔp

The mathematical description of the surface defining the power of the motor in all operating points, according to representation 8 thus results from the following equation:

$${P}_{1} ( {ω}_{e} , s ) = {v}_{s} \cdot {[ \begin{matrix}{IR}_{s} + J {ω}_{e} ( {L}_{ls} + {L}_{m} ) - \\ J {ω}_{e} {{L}_{m} ( \frac{{R}_{r}}{s} + J {ω}_{e} ( {L}_{lr} + {L}_{m} ) )}^{- 1} J {ω}_{e} {L}_{m}\end{matrix} ]}^{- 1} {v}_{s} \qquad ( Equation 8 )$$

wherein it is assumed that the supply voltage is given by the vector

$$[ \begin{matrix}{V}_{sd} \\ {V}_{sq}\end{matrix} ] = [ \begin{matrix}{K}_{1} {ω}_{e} + {K}_{0} \\ 0\end{matrix} ] .$$

Rₛ (stator resistance), Lₗₛ (inductive losses of the stator), Lₘ (magnetic induction) Lₗᵣ (inductive resistance of the rotor), Rᵣ (rotor resistance) and J

$$( matrix [ \begin{matrix}0 & - 1 \\ 1 & 0\end{matrix} ] )$$

are the constants of the motor.

The power at the entry of the pump 2a according to representation 9 as is known may be described by the pump equation

P₂(q,ωᵣ)=−a_{P2}q²ωᵣ+a_{P2}qωᵣ²+a_{P0}ωᵣ³+Bωᵣ² (9)

in which the constants a_{T2}, a_{T1}, a_{T0} and B are the pump constants

The power prevailing at the exit of the pump 2a according to the representation 10 may be described by the following equation:

P₃(q,ωᵣ)=−aₚ₂q³+aₚ₂q²ωᵣ+aₚ₀qωᵣ²+p_{offset}q (10)

The constants in this equation are aₚ₂, aₚ₁, aₚ₀ and p_{offset}.

The three dimensional surfaces represented by way of the representations 8, 9 and 10 in FIG. 2a, which in each case describe the power at the interfaces before, between and behind the function units 1a and 2a, are detected and stored at a point in time t₁. The detection is effected typically during the normal operation for a short time duration which with respect to the monitoring interval (time from t₁ to t₂) is negligibly small, whereupon then, after a longer time duration, specifically at the point in time t₂, this procedure is repeated so that the surfaces according to the representations 8′, 9′ and 10′ result. Thereby, the surfaces 8 and 8′ as well as 9 and 9′ and finally 10 and 10′ are compared to one another at the point in time t₁ and t₂. The assembly operates in an unchanged manner when the surfaces correspond. If these surfaces however are distanced to one another at an operating point, then one of the function units has changed its power characteristics, typically worsened. If thus for example, a distance between the surfaces according to the representation 10 and 10′ and in the other agreeing surfaces is ascertained, then it is to be assumed that although the motor 1a operates with an efficiency which has not reduced, that however a procedure changing the efficiency has taken place within the pump 2a. Vice versa, with a change of the surfaces according to the representations 9 and 9′, one may deduce constant pump power characteristics, but with a changed motor efficiency.

With the monitoring as is represented by way of FIG. 2a, a power monitoring in front of and behind every function unit 1a, 2a is effected. One may however forgo this depending on the application. The multidimensional surface courses which represent the input power or output power and which have a model character, as are also defined by the Equations 8, 9 and 10 also do not necessarily need to be determined, but, as the embodiment example according to FIG. 2b illustrates, e.g. instead of the power P₃ according to representation 10 in FIG. 2a, alternatively one may determine the hydraulic power characteristics, thus the differential pressure mustered by the pump 2a in dependence on the drive rotational speed ωᵣ and the throughput rate q which is detected and stored at the point in time t₁. The multidimensional surface specified in the representation 10a as well as the surface shown in representation 10a′ at the point in time t₂ is defined in each case by the equation

Δp(q,ω₂)=−aₚ₂q²+aₚ₂q¹ωᵣ+aₚ₀ωᵣ²+p_{offset} (10a)

A further possibility of monitoring such a pump assembly consisting of the function units 1a and 2a is represented by way of FIG. 2c. As is clarified in the representation 11, there the power P₁ is detected in dependence on ωₑ and Q according to the representation 8a and is compared to the respective power according to representation 8a′ in the temporal interval between t₁ and t₂. There the power P₂ is also determined in dependence on Δₚ and ωᵣ, as the representation according to 9a and 9a′ respectively illustrates. Finally, with the monitoring concept represented by way of FIG. 2c, the efficiency of the motor ηₘ as well as the efficiency of the pump ηₚ are directly monitored as the representations 11a and 11b or 11a′ and 11b′ clarify. These differences are merely to clarify that there is a multitude of possibilities of monitoring the power characteristics of the whole device but also of the function units of these, as has been clarified previously by way of the centrifugal pump assembly consisting of the function units of the motor 1a and the pump 2a.

The efficiency of the motor ηₘ is the quotient of P₂ and P₁ and is dependent on ωₑ (the supply frequency) and s, the slip of the motor. The motor efficiency is represented in FIG. 2c in the representation 11a by the surfaces of the diagram at every operating point. In the representation 9a, the power P₂ is shown in dependence on Δp and q. From this results the efficiency of the pump ηₚ in dependence on the pump rotational speed (ωᵣ) and the delivery quantity q, as the surface represented in 11b illustrates. The power P1 of the motor 1a in dependence on the supply frequency and the throughput rate of the pump is represented in 8a likewise in the form of a surface. Analogously to FIG. 1, the powers or efficiencies represented by way of the surfaces 8a, 9a, 11a and 11b are determined and stored at the point in time t₁, wherein corresponding comparative surfaces have been determined at the point in time t₂, wherein the distance of the surfaces in the representations 11a and 11a′ as well as 11b and 11b′ are used as a measure for the efficiency change. If for example the efficiency of the pump 2a reduces in the course of time t₁ to t₂ on account of bearing damage, then the surfaces in the representations 11a and 11a′ lie in one another, whereas the surfaces in the representations 11b and 11b′ have a significant distance to one another, with respect to an operating point. A volume may also be defined instead of this distance.

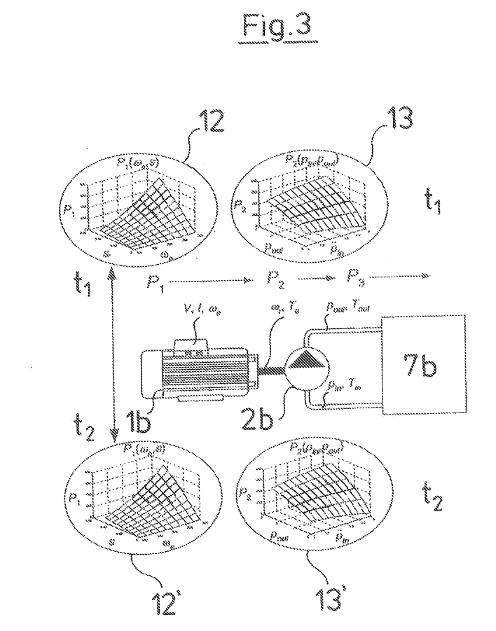

By way of example, FIG. 3 shows how a compressor may be monitored with the method according to the invention. The compressor comprises a function unit 1b in the form of a motor and a function unit 2b driven by this, in the form of a displacement pump which feeds a consumer 7b. Here too, a surface according to representation 12, which represents the motor power, as well as a surface according to representation 13, which represents the pump power, are determined and stored at a point in time t₁, and at a temporal interval, for example at point in time t₂, corresponding to the representations 12′ and 13′ are determined by way of current values at point in time t₂ and compared to the stored ones, wherein here too, the distance of the surfaces according to the representations 12 and 12′ or 13 and 13′ and the volume spanned therebetween is used as a measure for the worsening of the efficiency. The numerical relations result as follows:
pᵢₙ˜entry pressure at the compressor [bar]
pₒᵤₜ˜exit pressure at the compressor [bar]
Tᵢₙ˜entry temperature at the compressor [° K]
Tₒᵤₜ˜exit temperature at the compressor [° K]
ωᵣ˜rotational speed of the shaft driving the compressor [U/sec]
P₁˜electrical power [W] taken up by the motor
P₂˜power at the drive shaft [W]. The power P₂ is proportional to the slip of the motor s. This is P₂∝s.

Furthermore the following mathematical relations apply:

$${P}_{2} = {ω}_{r} {T}_{e}$$

$$\frac{n - 1}{n} = \frac{ln ( {T}_{out} ) - ln ( {T}_{in} )}{ln ( {p}_{out} ) - ln ( {p}_{in} )}$$

With an adiabatic compression cycle thus the power P₂ results as follows:

$${P}_{2} = {k}_{0} {ω}_{r} {p}_{in} ln ( \frac{{p}_{out}}{{p}_{in}} ) + {k}_{1} {ω}_{r}^{2} + {k}_{2} {ω}_{r}^{3} \qquad ( 13 )$$

wherein k=ΔV/(2π).

For the case that no adiabatic process occurs in the compressor, the power may be specified as follows:

$${P}_{2} = {k}_{0} {ω}_{r} {p}_{in} ( {( \frac{{p}_{out}}{{p}_{in}} )}^{\frac{n - 1}{n}} - 1 ) + {k}_{1} {ω}_{r}^{2} + {k}_{2} {ω}_{r}^{3} ,$$

wherein k=ΔV n/(n−1)/(2π), wherein n is a constant not equal to 1, which describes the heat flow during the compression. If the process occurs amid constant temperature, then n may likewise be assumed to be constant. The expression n/(n−1) results from the following equation:

Tₒᵤₜ=Tᵢₙ(Pₒᵤₜ/Pᵢₙ)^{(n-1)/n}

This means that this expression may be determined as follows by way of the temperatures Tᵢₙ and Tₒᵤₜ as well as the pressures Pₒᵤₜ and Pᵢₙ:

$$\frac{n - 1}{n} = \frac{ln ( {T}_{out} ) - ln ( {T}_{in} )}{ln ( {p}_{out} ) - ln ( {p}_{in} )}$$

The motor power P₁ may be monitored in an analogous manner as above by the equation (8).

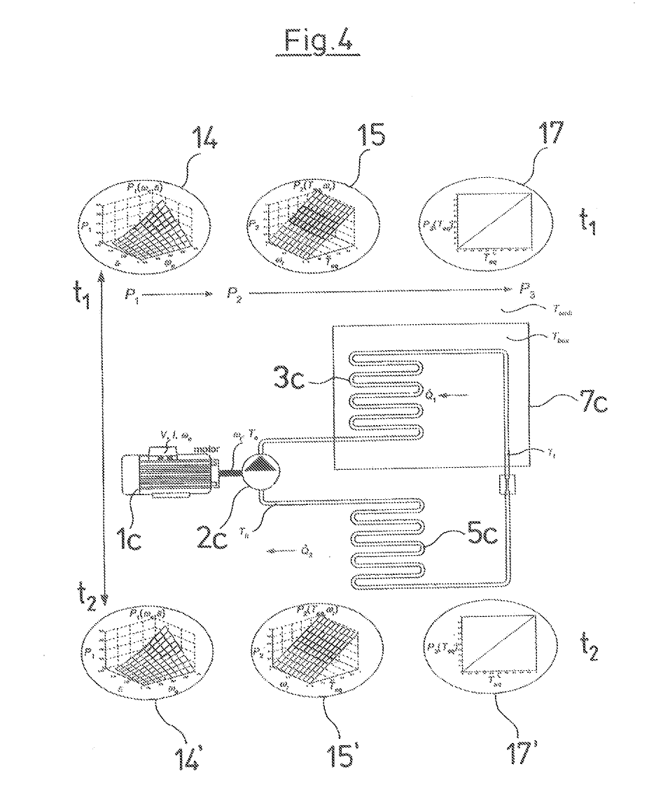

The method according to the invention is represented for a refrigerator by way of FIG. 4, consisting of a motor 1c, of a displacement pump 2c, whose exit affects an evaporator 3c which via a throttle 4c is connected to a condenser 5c, whose exit is conductively connected to the entry of the pump 2c. The cooling space is indicated at 7c.

The following variables result in this system:

T₁˜temperature at the exit of the evaporator 3c

Tₕ˜temperature at the entry of the condenser 5c

T_{box}˜temperature in the refrigeration space 7c

T_{amb}˜surrounding temperature

Q₁˜cooling power

Q₂˜power given to the surroundings

W˜power given by the pump 2c

ωᵣ˜speed of the motor shaft [U/sec]

Tₑ˜torque [Nm]

P₂˜mechanical power yielded by the motor

These are in the following mathematic relation:

$${P}_{2} = {ω}_{r} {T}_{e} {T}_{eq} = \frac{{T}_{h} - {T}_{l}}{{T}_{l}} \cdot ( {T}_{amb} - {T}_{box} )$$

The surface according to representation 14, which describes the power of the motor 1c corresponds to that according to the representation 12 in FIG. 3 or representation 8 in FIG. 2a. The resulting relations result for the surfaces defining the power P₂ and P₃:

$$\begin{matrix}{P}_{2} = {R}_{th} \cdot \frac{{T}_{h} - {T}_{l}}{{T}_{l}} \cdot ( {T}_{amb} - {T}_{box} ) + {K}_{ω} \cdot {ω}^{3} & ( 15 ) \\ {P}_{3} = {R}_{th} \cdot \frac{{T}_{h} - {T}_{l}}{{T}_{l}} \cdot ( {T}_{amb} - {T}_{box} ) & ( 17 )\end{matrix}$$

The equation 15 thereby describes the power P₂ at the entry of the compressor, whereas the equation 17 describes the power at the exit of the compressor. As in particular the representation 17 illustrates, the surfaces to be determined for determining the power at the surfaces of the function units may be two-dimensional or multi-dimensional. The surface according to representation 17 is two-dimensional, thus a line. The remaining surfaces represented here are all three-dimensional. It is to be understood that these surfaces, as the case may be, may also be more that three-dimensional depending on the type of the machine to be monitored and the mathematically physical relations which lie behind this.

Here too, the monitoring is effected in an analog manner, by way of the surfaces according to representations 14, 15 and 17, said surfaces specifying the power at the interfaces of the function units, being determined at point in time t₁ as well as after a temporal interval at point in time t₂ (then the surfaces according to the representations 14′, 15′ and 17′ result), in order then, by way of determining the distance of the surfaces or the volume spanned therebetween, to determine which of the function units 1c, 2c have dropped in their efficiency by which amount.

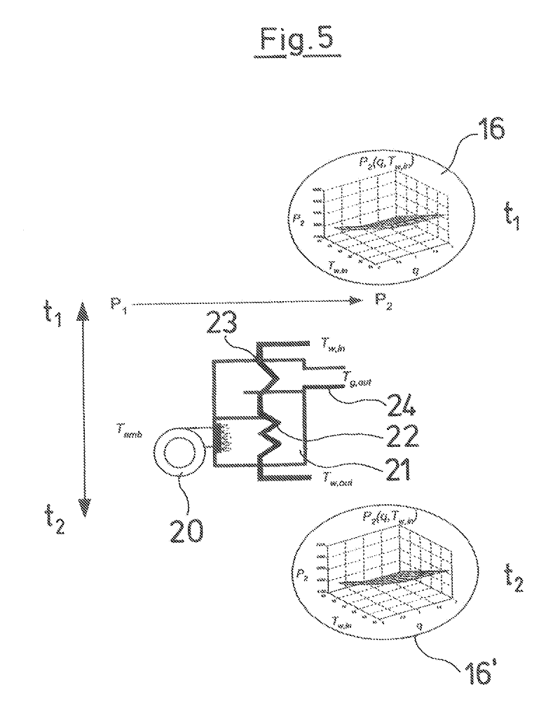

Finally, by way of FIG. 5, it is represented how the monitoring method according to the invention may be applied to the primary circuit of a heating installation. The heating installation comprises a burner 20 which heats water in a conduit 22, in a combustion space 21. The water heated by the burner 20 is led in the primary circuit of the heating installation and, after the removal of its heat, gets into a heat exchanger 23, in which the exhaust gas exiting from the combustion space 21 gives its heat to the water. The exhaust gas gets into the surroundings via the exit 24. The variables of this system are:

Q˜volume flow of the water flowing through the conduit 22

\dot{m}_{g}˜exhaust gas mass

T_{w,out}˜the temperature of the water exiting from the conduit 22

T_{w,in}˜the temperature of the water entering into the conduit 22

T_{g,out}˜the temperature of the exhaust gas at the exit

T_{g,in}˜the combustion temperature

T_{amb}˜the temperature of the surroundings

P₁˜the power introduced into the system by the fuel

P₂˜the power removed from the system by the water

Hereby the following relations result:

P₂=ρwqCpw(Tw,out−Tw,in)

in which ρ_{w} represents the density of the water and C_{pw} the specific heat capacity of the water. The surfaces to be computed hereby result as follows and are specified at the point in time t₁ by the representation 16 and at the point in time t₂ by the representation 16′:

$${P}_{2} = {\overline{P}}_{1} - {\overline{\dot{m}}}_{g} {C}_{pg} {T}_{w , in} - {\overline{\dot{m}}}_{g} {C}_{pg} ( \begin{matrix}{\overline{T}}_{g , in} - \\ {T}_{w , out}\end{matrix} ) {e}^{- \frac{UA}{{\overline{\dot{m}}}_{g} {C}_{pg}} - \frac{UA}{q {ρ}_{w} {C}_{pw}}} + {\overline{\dot{m}}}_{g} {C}_{pg} {\overline{T}}_{amb} \qquad ( 16 )$$

wherein C_{pg} and C_{pw} are the specific heat capacity of the exhaust gas, U the heat transfer coefficient and A the heat transfer surface between the burner 20 and the conduit 22. Thereby, the power P̅ᵢₙ led away by the exhaust gas and the mass flow {dot over ( m̅_{g} of the exhaust gas is to be assumed as being constant, just as the surrounding temperature T̅_{amb}. As the case may be, these variables may also be determined in a simple way by way of measurement.

As the above embodiment examples illustrates, the method according to the invention may be applied with the most varied of devices such as assembles, machines and installations, wherein advantageously the multidimensional surfaces are evaluated, which in each case define the power at the interfaces of the function units to one another in any operating point, and thus a reliable measure for the power characteristics of the function units as well as, with a suitable evaluation, of the whole device results when these are compared to one another at different points in time (e.g. t₁ and t₂). It is to be understood that the points in time t₁ and t₂ here are only to be understood by way of example, usefully the values determined at the point in time t₁ are constantly stored, in order to be able to compare them with later ones, which however does not rule out intermediate values also being stored, in order, as the case may be, to also detect the speed of the change. This too may be evaluated in a suitable evaluation device. Inasmuch as this is concerned, EP 1 564 411 A1 is referred to, where comparable evaluations are described in detail.

At this place, it is to be noted that with the previously represented embodiment examples, it was always two-dimensional or multidimensionally surfaces which have been used for determining the power balance at the interfaces of the function units, since this permits an evaluation practically independent of the respective operating point. With essentially constant operating points, these evaluations may also be effected in a simplified manner by way of individual variables being compared to one another at a temporal interval, by way of which one may directly or indirectly obtain information on the efficiency. The two-dimensional or multi-dimensional surfaces which are being discussed are advantageously determined during operation, wherein one attempts to achieve a high accuracy of the surfaces on the basis of as few as possible different operating points by way of suitable iteration methods. This may be achieved in particular by way of using a Kalman filter, as has been described further above. However other suitable iteration methods may also be applied. It is also conceivable for example, with a pump assembly, to travel to certain operating points in a targeted manner, in order to detect the surface representing the power balance with an accuracy as high as possible, or by way of moving to defined operating points in a targeted manner to be able to make do with determining such surfaces.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-19. (canceled)

20. A method for monitoring an energy conversion device, which includes at least two function units which are functionally linked to one another, with which power-dependent variables of at least one function unit of the at least two function units are automatically detected and/or computed in temporal intervals, and are compared to one another or to values derived therefrom and/or to predefined values, and a corresponding signal is produced in dependence on the comparison.

21. The method according to claim 20, with which the power-dependent variables of the at least two function units which are functionally linked to one another are detected and/or computed, in an automatic manner in temporal intervals, wherein power-dependent exit variables or variables derived therefrom, of the one function unit, form power-dependent entry variables of a second function unit which is functionally arranged after the one function unit.

22. The method according to claim 20, with which the comparative values or comparative functions are formed by way of the power-dependent variables, which are envisaged and suitable for power comparison which is independent of operating point.

23. The method according to claim 20, in particular for operational optimization and/or for monitoring the energy consumption or the efficiency of an electric motor driven centrifugal pump assembly, with which in operation, at least one power-dependent variable of the motor and at least one hydraulic variable of the pump or at least two hydraulic variables of the pump, at a temporal interval, are compared to one another or by way of a mathematical link of these or to predefined values, and a signal characterizing the operating condition of the pump assembly is produced in dependence on the comparison.

24. The method according to claim 23, which is carried out during the correctly functioning delivery operation.

25. The method according to claim 23, which is repeated in temporal intervals, wherein the comparison is carried out on the basis of the previously detected variables or the predefined values.

26. The method according to claim 23, with which firstly electrical variables of the motor determining the power uptake of the motor, and at least one variable determining the hydraulic operating point of the pump are detected and stored, and with which in a temporal interval, on reaching a hydraulic operating point corresponding to the previously detected one, the electrical variables of the motor determining the power uptake of the motor are detected and compared to the firstly stored variables, whereupon a corresponding signal is produced.

27. The method according to according to claim 23, with which firstly the electrical variables of the motor which determine the power uptake of the motor, and the variables determining the hydraulic operating point of the pump are detected and stored, and with which these variables are detected again after a temporal interval, wherein the detected variables are transferred on the basis of a mathematical, electrical motor model and/or a mathematical hydraulic pump model and then compared to the stored variables, or vice versa, whereupon a corresponding signal is produced.

28. The method according to claim 23, with which the detection of power-determining variables of the motor and/or pump is only effected after the completion of a predefined time, which corresponds at least to the running-in phase of the pump assembly.

29. The method according to claim 28, with which, after completion of the predefined time, during the observation phase, automatically at least one operating profile is detected and the expected energy consumption is determined whilst taking into account the efficiency change which is determined as the case may be.

30. The method according to claim 20, with which a surface course which has a multidimensional model character and is dependent on the power of a function unit is determined by way of several operating points and stored, and such surface courses are determined afresh in temporal intervals and are compared to the previously determined ones.

31. The method according to claim 30, with which the distance of the surface courses at a predefined operating point, or the volume spanned between the surfaces is used as a measure for the efficiency change, in particular an efficiency reduction.

32. The method according to claim 31, with which a Kalman filter is used for determining the surface course by way of the operating points.

33. A centrifugal pump assembly with an electrical motor and a centrifugal pump driven by the motor, characterized in that a device for monitoring the power characteristics of at least one function unit of the assembly is provided, which operates according to the method of claim 20.

34. A compressor assembly with an electrical motor and a displacement pump driven by the motor, characterized in that a device for monitoring the power characteristics of at least one function unit of the assembly is provided, which operates according to the method of claim 20.

35. A cooling assembly with an electric motor, with a displacement pump driven by the motor, with an evaporator and with a condenser, characterized in that a device for monitoring the power characteristics of at least one function unit of the assembly is provided, which functions according to the method according to claim 20.

36. A heating installation with a burner and at least one water circuit which may be heated by the burner, characterized in that a device for monitoring the power characteristics of at least one function unit of the installation is provided, which operates according to the method of claim 20.

37. An assembly/installation according to claim 20, wherein after a predefined time after starting operation of the assembly/installation, the device automatically begins with the detection and storage of the variables which are relevant to determining the efficiency.

38. An assembly/installation according to claim 37, wherein the device comprises a memory in which at least the variables detected at the beginning of the measurement, or variables derived therefrom, are stored.
